(19) United States
(12) Patent Application Publication
(10) Pub. No.: US 2022/0234288 A1
(43) Pub. Date: Jul. 28, 2022

(54) METHODS FOR USE IN PRINTING

(71) Applicant: 3DM DIGITAL MANUFACTURING LTD., Rosh Ha'Ayan (IL)

(72) Inventor: Daniel Majer, Givat Shmuel (IL)

(21) Appl. No.: 17/617,766

(22) PCT Filed: Jun. 18, 2020
(86) PCT No.: PCT/IL2020/050679

§ 371 Date: Dec. 9, 2021

Related U.S. Application Data
(60) Provisional application No. 62/862,980, filed on Jun. 18, 2019.

(51) Int. Cl. B29C 64/182; B33Y 10/00; B33Y 30/00; B33Y 50/02; B29C 64/153; B29C 64/393; B29C 64/295; B29C 64/268; B29C 64/277

(52) U.S. Cl. CPC B29C 64/182; B33Y 10/00; B33Y 30/00; B33Y 50/02; B29C 64/277; B29C 64/393; B29C 64/295; B29C 64/268; B29C 64/153

(57) ABSTRACT

The invention provides a powder bed printing system and process which reduces the time period needed to complete the recoating and heating of each material layer in the process, thereby reducing process overhead and printing time.

### TECHNOLOGICAL FIELD

The invention disclosed herein generally concerns methodologies for use in printing such as 3D printing.

### BACKGROUND ART

3-dimensional (3D) printing is an Additive Manufacturing (AM) or Rapid Prototyping (RP) process of making a three-dimensional solid object of virtually any shape from a digital model. 3D printing is achieved using an additive process, where successive layers of material are laid down one on top of the other. 3D printing is considered distinct from traditional machining subtractive processes techniques which mostly rely on material removal by methods such as cutting or drilling.

There are several leading 3D printing technologies dominating the market today:

1. SLS-Selective Laser Sintering systems use a plastic powder bed and selective sintering by means of a CO₂ laser beam. Though the resulting models are made of engineering plastics, the surface is very rough, small details are impossible to achieve due to poor laser resolution and building speed is low due to vector-type imaging The machines are very expensive due to their physical size dictated by the CO₂ optical path.

2. SLA-Stereo Lithography Systems use UV laser for selectively curing layers of liquid photopolymer. UV lasers have a great optical quality and combined with a short wavelength allow fine resolution imaging. The resulting parts have good surface quality and fine details are obtainable. However, the cured photopolymer has poor elastic and thermal quality making it impossible using the 3D printed parts as functional parts. The speed is also low due to vector imaging.

3. Inkjet Photopolymer is another way to produce 3D models by curing photopolymer layers. An array of inkjet nozzles images 2D slices of the model. A UV lamp cures the layer immediately after the imaging producing solids in imaged areas. Inkjet allows faster imaging and throughput scalability by increasing the number of nozzles. It produces resolution comparable to SLA though surface quality and the level of details remain worse than that obtained with SLA. Though the choice of materials offered by inkjet systems is impressive in its variety, none of them are truly functional due to the fact that these are still photopolymers with the same qualities as in SLA.

4. FDM-Fused Deposition Modeling is based on a thermoplastic filament passing through a heated nozzle. The heat turns the plastic into soft paste. The nozzle moves in an X-Y plane, vector imaging each layer. A feed motor is responsible for pushing the filament down the nozzle in a controlled fashion. The method can produce models from engineering plastics.

Despite the diversity of 3D printing methodologies, current 3D printing systems suffer from many drawbacks. The majority of 3D printers today use photopolymer replacements for engineering plastic materials. These materials do not have the mechanical properties of the plastics they mimic They have a different feel than the plastics they are supposed to replace and are very expensive. 3D printers that do use engineering plastics are mostly high end, expensive, low-resolution machines that use just one or two plastic materials from the vast array of possible plastics available.

Many of the current 3D printers also produce low resolution parts compared to other methods of manufacturing. Also, printing speed is extremely slow; an object may take many hours or even days to print.

### PUBLICATIONS

[1] U.S. Pat. No. 6,930,278,
[2] US Patent Application No. 2004/0200816,
[3] US Patent Application No. 2008/0257879,
[4] US Patent Application No. 2017/0341307,
[5] US Patent Application No. 2016/0082268,
[6] U.S. Pat. No. 10,112,260, and
[7] EP Patent No. 3,159,080.

### GENERAL DESCRIPTION

Powder bed 3-dimensional (3D) printing process is a layer-by layer process which involves the use of a laser selective melting or sintering (selective laser sintering, SLS). In a typical powder bed printing process—following deposition of a layer of a powder material on a printing powder bed—the powder layer is heated to a temperature just below the melting temperature of the powder and thereafter scanned with a high power laser to fuse small particles of the powder material (e.g., plastic, metal, ceramic or glass material) into a mass of a desired 3D shape. Each of the layers formed and fused constitute a horizontal or a vertical cross-section of the final 3D object. After each cross-section is scanned, the powder bed is lowered by a one layer thickness and a new layer of the same or different powder material is applied on top and the process is repeated until the 3D object is completed.

One of the known disadvantages associated with the use of a powder bed 3D printing process is the long overhead time inherent to the step-wise process. While the SLS step may be completed within 2-5 seconds, typically the time period for powder recoating and heating may be at least twice as long, i.e., about 5-10 seconds, and in some cases even longer; hence the time required for completion of a single fused cross-section is rather high and the overall time required to manufacture a full 3D object inherently includes high overhead time.

It is therefore the inventor's aim to provide a powder bed printing system and process which reduces the time period needed to complete the recoating and heating of each subsequent material layer in the printing process, thereby reducing the overhead and printing time as a whole.

It is a general object of the invention to provide improvements to known printer systems and processes, wherein said improvements provide shorter overhead and overall printing times as well as improved properties of the final printed 3D object, as further detailed below.

All powder bed printers have powder beds and heating elements. The present invention provides improvements in both aspects of the technology and hence an overall improved 3D powder bed printing technology.

In more specific terms, processes of the invention provide parallel (or simultaneous) processing steps according to which the recoating and heating steps in the production of one 3D object run parallel to (or substantially simultaneously with) the SLS steps in the production of a second 3D object, thereby providing an overall reduction in the time necessary to manufacture a complete 3D object or a plurality of objects. This parallel processing is achieved in a powder bed printing system that comprises a plurality of printing area (being more than one, or two or more printing areas of a printing bed or a more than one, or two or more or a plurality of printing beds), wherein on each of the printing areas, or beds, independently from the other, two or more different 3D objects may be printed. Accordingly, systems and processes of the invention, significantly reduce the printing time of multiple 3D objects relative to the time required to print a single identical 3D object following the three-step process of the art or relative to the time required to print the same number of 3D objects in sequence.

As used herein, the term “powder bed printing” system or process comprises any additive manufacturing process which utilizes powder materials, wherein non-limiting examples of said materials include metal, ceramic, polymer and composite powder materials and which involve fusion of material particles by exposing them to thermal energy, such as a laser, an electron beam and/or infrared light.

According to a first aspect of the invention a powder bed 3D printing system is provided that comprises plurality of printing areas, a powder coating assembly, a print head assembly and one or more heating units, wherein each of the plurality of printing areas is provided in a form of a powder bed surface defining at least two printing areas, or two or more powder beds, wherein the system is configured and operable for simultaneous printing of two or more 3D objects.

In some embodiments, the system comprises a plurality of printing areas in a form selected from (a) a powder bed having a surface defining at least two printing areas, and (b) two or more separate powder beds. In some embodiments, the system comprises one or more powder beds, at least one of which having a plurality of printing areas. In some embodiments, the system comprises a single powder bed having surface defining a plurality of printing areas.

In some embodiments, the system comprises two or more powder beds, each of the beds is configured and operable as a plurality of spaced apart printing areas, wherein each of the printing area is designed or used for the production of a 3D object. Selective laser patterning (e.g., melting, sintering) allows for a high density of objects to be formed on each powder bed, such that the distance between the objects may be sufficiently small, thereby enabling simultaneous manufacturing of a high number of 3D objects on two or more powder beds.

In some embodiments, the system comprises at least two powder beds, e.g., between 2 and 10 powder beds. In such embodiments, the system is operable to printing simultaneously on two or more beds, producing two or more 3D objects (over all or on each of the beds).

In a system of the invention, the powder coating assembly comprises (i) at least one powder coating or recoating mechanism, which may or may not be heated, each mechanism comprising at least one (or a set of) roller(s) or blade(s), (ii) at least one powder supply unit, optionally two per each of the coating or recoating mechanisms, each of which may or may not be heated, and optionally (iii) at least one powder overflow cartridge for collecting left over powders.

It is understood that the term coating, encompassing also recoating, has the meaning known in the context of powder 3D printing and Additive Manufacturing technologies.

The print head assembly, optionally movable in proximity (namely in an effective distance as known and acceptable in additive manufacturing or SLS printing methodologies) and over (namely above and at an effective distance from) each of the two or more printing areas (namely the powder bed having at least two printing areas or two or more powder beds), comprises a print head in the form of an array of lasers or laser mirror scanners, such that the array of lasers or each of the two or more printing areas is/are configured to movably position in a radiation path of a laser beam. The array may comprise one or a plurality of lasers. Where applicable, the lasers may be replaced (completely or partially) with any one or more source of thermal energy, e.g., electron beam or infrared light.

In some embodiments, the laser used is a quantum cascade laser (QCL), a CO₂ laser, a fiber laser, a diode laser or any other laser typically used with powder bed printing systems. In some embodiments, the assembly comprises at least one QCL or an array of at least two QCL, at least two CO₂ lasers, at least two fiber lasers, at least two diode lasers or a combination of two or more laser types.

The heating unit utilized in a system of the invention comprises at least one infrared emitter (optionally arranged in the form of an array) for powder heating or preheating. A heating unit may be positioned in proximity or be part of any of the system's features, enabling effective heating or preheating. The heating unit may be a movable unit. To enable accurate and efficient heating of the powder layer(s), the unit may further comprise or be associated with one or more temperature sensors for measuring the temperature of the powder prior to, during or after powder heating. Non-limiting examples of temperature sensors include infrared cameras or pyrometers capable of measuring the powder temperature from a distance. Heating of the powder may be by a single irradiation session or by more than one irradiation session. In some embodiments, irradiation is directed to each layer independently. The heating may be repeated or continued until a desired powder temperature is achieved.

A system of the invention may optionally further comprise at least one unit for controlling a digital alignment of a laser scanner or a plurality of laser scanners (or their equivalent). The at least one unit may be in the form of one or more cameras for general process control.

In a system of the invention, one or more substantially stationary or movable (99% stationary) powder beds having each two or more printing areas or two or more powder beds are provided at an effective distance from a stationary or movable print head assembly and also from a stationary or movable heating unit. The powder coating assembly is configured to move across the one or more of the powder beds, coating the one or more printing areas (namely on a single bed or on a plurality of powder beds, e.g., printing areas 1 and 2, or powder beds 1 and 2) with a layer of a powder material. The heating source is subsequently moved into position in proximity of the coated printing areas or beds (e.g., 1 and 2) which are thermally treated. A depiction of a process utilizing a system of the invention is provided in FIG. 5.

In some configurations of a system of the invention, the print head assembly and the heating sources are stationary and the powder bed(s) are moved in proximity thereto.

In some embodiments, the print head assembly and the heating sources, as well as the powder bed(s) move relative to each other.

Simultaneously with the coating and thermal treatment of the one or more coated printing areas or powder beds (e.g., 1 and 2), one or more other printing areas or powder beds (e.g., 3 and 4) that have undergone coating and thermal treatment are positioned under the print head assembly by moving the print head assembly into position over the printing areas, namely in proximity to (or at an effective distance from) a laser source or a laser mirror scanner and scanned to fuse the powder layer. Generally speaking, fusion of the powder layers refers to any means by which the powder becomes solidified. Solidification may be achieved by sintering, melting followed by cooling and solidification polymerization or any other means known in the art.

Once the thermally treated printing areas or powder beds (e.g., 1 and 2) are at a predefined temperature, the print head assembly is moved into proximity with the printing areas or beds and scanned with the laser or any thermal source to thereby affect powder fusion. At the same time, the scanned printing areas or beds (e.g., 3 and 4) are recoated with a further layer of a powder material and thermally treated by the heating source.

The printing areas or powder beds are re-irradiated and re-coated once and again, in an alternate fashion, by repeating the steps on two or a multiple number of printing areas or powder beds to achieve the simultaneous manufacturing of two or more 3D objects.

Systems of the invention may further comprise a controller that is configured and operated to control a plurality of processes. The controller or control unit may include a CPU and may be connected with various components in order to control the system operation.

The system may further comprise a user interface (UI) unit for providing, for example, a model design or graphical representation of an object to be formed. Examples of UI units include, without limitation, a graphical user interface (GUI) and web-based user interface. A computer system can monitor and/or control various aspects of the printing system. The control may be manual or programmed The control may rely on feedback mechanisms that have been pre-programmed The feedback mechanisms may rely on input from sensors that are in communication with the control unit. The computer system may store data concerning various aspects relating to the operation of the system. The data may be retrieved at predetermined times or when desired and may be accessed by the user. The data, which may be operative data or data relating to prior processing protocols, may be displayed on a display unit. The data may relate to the 3D object manufactured, the printing progress, factors relating to the processing times and time periods, parameters relating to process calibration or maintenance, temperatures and other conditions, and others.

Processes and systems of the invention can be implemented by way of one or more algorithms, e.g., by way of software upon execution by one or more computer processors. Suitable algorithms are known in the field.

The invention further provides a process for constructing two or more 3D objects, in a simultaneous fashion, e.g., wherein said process is intended to reduce overhead and overall time associated with the manufacture of each of the 3D objects, utilizing a powder bed printing system comprising a printing area in a form of (i) at least two printing areas on a powder bed, and/or (ii) two or more separate powder beds, one or more of the printing areas (i) and (ii) having been previously powder coated and thermally treated, the process comprising:

powder coating one or more printing areas or powder beds (e.g., 1 and 2) and thermally treating said coated printing areas or powder beds; simultaneously therewith treating the one or more of the previously powder coated and thermally treated printing areas or powder beds (e.g., 3 and 4) under conditions of selective laser sintering (SLS),

SLS treating the powder coated and thermally treated printing areas or powder beds (e.g., 1 and 2); and simultaneously therewith coating and thermally treating the SLS treated one or more previously coated and thermally treated printing areas or powder beds (e.g., 3 and 4), and

repeating the steps to construct the 3D objects.

The process of the invention, and a system employing same, permits construction of two or more 3D objects “in a simultaneous fashion”. In other words, at any time point, in a process of the invention, two or more 3D objects are at different stages of manufacturing, or at any time point, two or more powder beds or printing areas or regions on a powder bed are processed for producing two or more 3D objects. While one of the constructed 3D objects may be at an initial stage of manufacturing, another of the objects may be at a more advanced stage of production. In some cases, more then two beds or areas may be at the same exact processing steps, while others may be at a different processing stage.

Further provided by the present invention are 3D objects manufactured in accordance with the process of the invention.

In some embodiments, the number of powder beds is between two and ten. In some embodiments, the number of beds is two.

In some embodiments, the step of adjusting the temperature of the powder coating comprises:

(a) heating with a heating element having a fixed (constant) thermal radiation (amount and spectra) a first powder layer to a temperature T₁, being lower than the sintering temperature of the at least one powder material, over a period t₁;

(b) determining (by direct or indirect temperature measurements) the temperature of the first powder layer;

(c) if the temperature of the first powder layer is lower than the sintering temperature, coating a second powder layer on the first powder layer and heating the second powder layer with the heating element for a period t₂ being greater than t₁; and

(d) repeating steps (b) and (c) one or more times until the sintering temperature is achieved.

Further embodiments of the thermal adjustment method are provided below.

As mentioned herein, a 3D printing process is a layer-by layer process wherein each dispensed layer of a material may be pre-heated to a certain temperature before sintering. In powder bed SLS printers, including systems of the invention, heating of the powder material is achievable by use of a heating source, typically prior to the step of laser sintering. In other words, laser sintering is carried out on a previously heated powder material. However, in some instances or configurations of processes and systems of the invention, heating the powder material with a heating source prior to laser sintering may be unnecessary as heating and fusion by the laser itself may suffice.

Various methods for heating material layers in 3D printing have been described [1-4]. However, in these known methods, the material layer is heated to a pre-set temperature by adjusting the energy/heat output of the heating sources or elements. In these methods, the various heat radiations effect the material layer differently. For example, when a layer is heated by a variant heat output, the penetration of the heat into the material layer can be different and hence the heating may vary between layers. Variant temperatures of the layers can affect the mechanical properties of the 3D object, for example by causing deformations and brittleness. When the heating process of the material layer is consistent and stable i.e., a consistent intensity of heat penetrates a constant depth of the material layer, the 3D object obtained under such conditions is endowed with better mechanical properties (less deformations, improved uniformity and strength).

In an attempt to reduce these and other deficiencies associated with the use of such heating elements, the inventor has contemplated use of a fixed thermal radiation (amount and spectra). The fixed radiation is provided by a heating element which can be set to provide thermal radiation that is selected and determined based on the material and process parameters employed in the printing of a 3D object. The use of fixed (constant) thermal radiation (amount and spectra) provides a constant, consistent and stable heating of a material layer in 3D/additive manufacturing processes.

Thus, in another aspect, the invention provides a process for adjusting temperature of a powder layer comprising at least one powder material in a printing process, the process comprises:

(a) (selectively) heating with a heating element having a fixed (constant) thermal radiation (amount and spectra) a first powder layer to a temperature T₁, being lower than or equal to the sintering/melting temperature of the at least one powder material, over a period t₁;

(b) determining (by direct or indirect temperature measurements) the temperature of the first powder layer;

(c) if the temperature of the first powder layer is lower than a temperature T₁ or the sintering temperature, coating a second powder layer on the first powder layer and selectively heating the second powder layer with the heating element for a period t₂ being greater than t₁;

(d) repeating steps (b) and (c) one or more times until the desired process temperature (T₁) or the sintering temperature is achieved.

In some embodiments, the process comprises:

(a) thermally treating a preformed first powder layer comprising at least one powder material with a heating element having a fixed (constant) thermal radiation (amount and spectra) for a period of time t₁ sufficient to increase the temperature of the first powder layer to a predetermined set-point temperature T₁;

(b) determining (by direct or indirect temperature measurements) the temperature of the thermally treated first powder layer, such that:
(b1) if the temperature determined is T₁, the period of time required to heat the first powder layer is t₁;
(b2) if the temperature determined is lower than T₁, determining a period of time t₂ that is greater than t₁; or
(b3) if the temperature determined is greater than T₁, determining a period of time t₂ that is smaller than t₁;
(c) forming a further powder layer comprising the at least one powder material on said thermally treated first powder layer;
(d) thermally treating said further powder layer with the (same) heating element for a period of time determined by the measured T₁ (namely for a period t₂ that is greater than or smaller than t₁, i.e., depending on whether the measured temperature upon exposure for a period of time t₁, was greater or lower than T₁);

(e) determining the temperature of the thermally treated further powder layer, such that:
(e1) if the temperature determined is T₁, the period of time required to heat the powder layer is t₂;
(e2) if the temperature determined is lower than T₁, determining a period of time t₃ that is greater than t₂; or
(e3) if the temperature determined is greater than T₁, determining a period of time t₃ that is smaller than t₂;

and repeating steps (c)-(e) one or more times until the period of time required for achieving a temperature T₁, when using the heating element having a fixed (constant) heat radiation (amount and spectra), is determined.

The fixed or constant thermal radiation is characterized by a particular spectra and an amount of radiation, defined by radiation intensity, duration and pattern (continuous or pulsed).

In some embodiments, each of the formed powder layers are thermally treated in a single heating session, i.e., each layer is heated once before the next layer is formed there on top. In other words, each powder layer is heated once over a period being equal to t₁ or greater than t₁ (t₁ being equal to the initial thermal session). Following each heating session, having a length t₁, the temperature of the heated layer is measured.

In some embodiments, each powder layer is heated by one or more heating sessions, before the next layer is formed.

In some embodiments, the preformed first powder layer comprising at least one powder material is a single material layer. In other embodiments, the preformed first powder layer comprising at least one powder material is a plurality of material layers, each consisting or comprising the same at least one powder material.

In some embodiments, steps of the thermal treatment are performed by exposing the powder layer to a heating element such as an infra-red (IR) emitter.

In some embodiments, the temperature of the powder layer following thermal treatment is determined by a heat sensor capable of remotely detecting the temperature of the material layer. Such heat sensors/detectors may be IR cameras or pyrometers.

Temperature T₁ is a temperature below the sintering or melting temperature of the powder material. This temperature is also referred to herein as the process temperature or desired process temperature. As the powder melting occurs selectively only where the powder is heated, e.g., where the laser heats the powder, if the whole powder is heated to the melting point one may end up with a solid cake of the powder. The actual process temperature is determined experimentally to be optimal such that the printed part is formed as quickly as possible, does not deform during the printing process and can be easily removed from the powder cake when cooled.

In some embodiments, heating of the powder material is conducted for a period t₁ from an initial onset temperature that may be room temperature or the starting temperature of the powder material. In some cases, however, the period t₁ is shortened as the powder is preheated while in the powder reservoir or when dispensed via a heated powder dispenser. Thus, the powder may be dispensed at an initial temperature or at a temperature below temperature T₁, that is below the powder sintering temperature.

In a process of the invention, each layer is thermally treated, as disclosed and thereafter sintered (or cured). In some embodiments, curing may be achieved by thermally treating a plurality of deposited layers. The sintering temperature used may be determined according to the invention and may be based, inter alia, the material used in the printing process, the number of layers, the heating source used, etc.

The position of the heaters may vary based on the configuration of the system. The heaters may be positioned to enable heating of the powder beds only, or may be positioned such that the metal frame or metal surrounding of either the powder reservoir or the powder beds is preheated or continuously heated to maintain the powder at a constant temperature. In addition, or alternatively, the heaters may be positioned to provide isolated regions of preselected temperatures.

The time period t₁ is initially determined based on the material characteristics or may be randomly predicted. In cases where t₁ is determined to be too short or too long, namely to raise the powder temperature to a temperature below or above T₁, respectively, the time period t₁ is corrected (namely increased or shortened) to a time period t₂ which is not randomly determined, but rather is a function of the radiation t (time) and ΔT (temperature difference).

As indicated, t₂ may similarly be corrected until the time period needed to achieve T₁ is determined. Any corrected time period, tₙ, where n is any of the consecutive time points after t₁, may be similarly adjusted.

According to some embodiments of the invention, the heating of each layer is carried out in a single heating session. The single heating session is for a time t₁ followed by measuring of the temperature of the heated layer and sintering of said layer. The subsequent layer is heated for a time t₂ which is determined as mentioned above according to a function of t₁ and ΔT, followed by sintering of said subsequent layer. These steps are repeated. Hence, the time of heating (heating session) for every layer is determined based on the time of heating and ΔT of the previous layer.

As a person versed in the art would realize, the crux of this aspect of the invention is a heating process or heating step which is controlled solely by the time of exposure of the material layer to the heating element at a fixed radiation value. Hence, the control requires merely turning the heating element on and off in accordance with a calculated or determined or predicted time period. The energy (intensity) of the heating element is constant and is not changed throughout the process, with the heating element spectra remaining the same. Thus, the heat penetration into the material layer is consistent, providing improved mechanical properties to the final 3D object, e.g., less deformation and improved mechanical properties.

The advantages of the process of the invention have been demonstrated in the construction of dog bones from PA2200. In the process, the dog bones were printed, layer by layer, wherein each of the layers were about 100 microns thick. Mechanical stress strain tests revealed that employing methods according to the invention yielded objects that were superior to the those printed by other methods (see FIG. 3 as compared to FIG. 4). Stress strain tests showed that the printed dog bones had the highest elongation values as well as much higher Young Modulus.

While the heating process of the present invention has been described in the context of the present multi-bed/printing-area printer, said heating process may be employed in various printer configurations.

The invention further provides a heating module for use in an additive material manufacturing apparatus/printer, the heating module comprising:

a heating element adjustable to provide heat of a constant energy (intensity and spectra);

a means for determining temperature (e.g., a temperature sensor) of a layered material (at one or more regions thereof);

a control unit adapted to control on/off function of the heating element and optionally further comprising a processor programmed with a set-point temperature that the layered material is to reach.

As a person of skill would realize, the process of the invention may be suitable for use in a variety of 3D printing technologies/additive material manufacturing wherein a wide array of materials (such as powder, ink, suspension, polymeric compositions, plastic materials and metals) are employed. 3D printing technologies that are suitable to incorporate processes such as those of the invention include selective laser sintering, selective laser melting (metal), powder bed fusion and others. Both the system of the invention as well as methods of the invention utilize a plurality (two or more) of temperature sensors, such as pyrometers, or IR cameras and a plurality (two or more) of IR heating elements, the temperature across the powder bed is maintained substantially uniform, contribution to an efficient process and to the manufacturing of a mechanically improved and superior 3D object.

In a process for constructing a 3D object or for reducing overhead and overall time associated with the manufacture of a 3D object, utilizing a powder bed printing system of the invention comprising printing areas or powder coated and thermally treated beds, the process may comprise the use of a method step of monitoring and adjusting temperature of a powder layer.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 provides a plot of a layer temperature. Initial temperature stabilization takes about 15 layers (initial temperature step). Printing starts at layer 20. It is evident that the temperature of the printed layers is maintained in a narrow range of +/−1 degree. Thus, demonstrating the effectiveness of the heating profile.

FIG. 2 presents the IR Lamp time ON vs layer number. A plot of the time required to heat each layer (heating profile). It can be seen that until about the 15th layer, the system is on a learning curve to determine the time required for heating the layer. The IR on time then fluctuates slightly within a range to maintain the required process set point to compensate for temperature changes.

FIG. 3 presents the results of a mechanical stress strain test on dog bones manufactured on a commercially available SLS system. Values x, y and z represent printing orientation in the printer. Samples were tested per ASTM D-638 Type V standard at a speed of 5 mm per min. X direction: Young Modulus 2000 MPa (2%) Stress at max load of 50 N/mm² and elongation fracture point of less than 20%. Y direction: Young Modulus 1900 MPa (2%) Stress at max load of 48 N/mm² and elongation fracture point of less than 20%. Z direction: Young Modulus 2000 MPa (2%) Stress at max load of 43 N/mm² and elongation fracture point of less than 5%.

FIG. 4 presents the results of a mechanical stress test on dog bones manufactured on a SLS system according to the invention, utilizing thermal adjustment protocols recited herein. Values x, y and z represent printing orientation in the printer. Samples were tested per ASTM D-638 Type V standard at a speed of 5 mm per min. X direction: Young Modulus 2200 MPa (2%) Stress at max load of 52 N/mm² and elongation fracture point of 45%. Y direction: Young Modulus 2300 MPa (2%) Stress at max load of 52 N/mm² and elongation fracture point of 42%. Z direction: Young Modulus 2100 MPa (2%) Stress at max load of 50 N/mm² and elongation fracture point of 35%. Test results are better in all orientations x y and z. Most notably the results of fracture point are much better in the 3DM scheme X: 45% vs. 18%. Y: 43% vs. 18% and Z: 35% vs. 4%. This shows the mechanical properties of PA12 printed in the protocol described here are significantly improved compared to state of the art of SLS technology.

FIG. 5 provides an exemplary 2-powder bed system according to the invention.

### DETAILED DESCRIPTION OF EMBODIMENTS

### Exemplary Two-Powder-Bed System According to the Invention:

1) Optionally, at least one heating element engineered to heat the whole inside of the printer environment.
2) An optional ventilator for enhanced temperature uniformity.
3) Two powder beds.
4) Two powder recoating mechanisms, each including at least one roller or blade.
5) A powder supply unit—optionally two such units per recoating mechanism to allow back and forth operation.
6) At least one powder overflow cartridge for collecting left over powder at both ends of the recoater movement.
7) A movable print head consisting of an array of laser scanners or an array of lasers without scanners.
8) One or two optionally movable IR emitter arrays for powder preheating.
9) One or more IR cameras or pyrometers to measure powder temperatures.
10) One or more cameras for process control especially for active digital alignment of multiple scanners.
   Exemplary Operation of a Two-Powder-Bed System or a Powder Bed with a Two-Printing Area According to the Invention:
1) Heat environment (air and powder beds etc.) to a 1^{st} temperature, e.g., for PA12 (Polyamide 12 aka Nylon 12) 140° C.
2) Dispense on each of the powder beds a powder layer—typically to a total thickness of 10-20 mm in total.
3) Initialize IR heaters stabilization process (same for both powder beds):
   i. Temperature Set point (T set)+range. Typical for PA12 170° C. +/−1° C.
   ii. Recoat powder (typical 100 μm layer thickness)
   iii. Heat using IR heaters for a given time with constant energy and spectrum
   iv. Read T of powder (T read) after IR heaters are off.
   v. Adjust IR heaters time—increase time if T read is less than T set. Decrease time if T read is more than T set.
   vi. Delta time can be a constant or a constant multiplying the difference between T set and T read for faster convergence.
   vii. Repeat until T read is stable in T set +/− range. Typically takes 5-20 layers to get there.
4) Initialize alignment procedure
   i. For each powder bed
   ii. Recoat powder layer
   iii. Heat with IR heaters
   iv. Melt or sinter powder using a digital alignment mark/fiducial mask for each scanner in the print head (4×4 in example).
   v. Take high resolution picture of entire print bed (melted parts look different than unmelted parts).
   vi. Determine all possible sintering inaccuracies (rotation, x and y movement, x and y distortion, misalignment between scan fields of all 16 scan heads).
   vii. Adjust said digital alignment mark/fiducial mask to correct for all inaccuracies.
   viii. Repeat i.-vi. Until within desired specification.
5) Printing
   i. Recoat 1^{st} powder bed
   ii. Heat with IR heaters.
   iii. Measure powder temperature in at least one area. Preferably in a non-sintered area due to emissivity changes between melted and un-melted powder.
   iv. Move print head to 1^{st} print head. Optional move IR heaters out of the way or to 2^{nd} powder bed.
   v. Melt or sinter per powder bed 1 3D object design per layer with optional addition of alignment marks outside object area.
   vi. Take a picture of 1^{st} print bed to calculate alignment changes.
   While iv.-vi. takes place:
   vii. Recoat 2^{nd} powder bed
   viii. Heat with IR heaters.
   ix. Measure powder temperature in at least one area. Preferably in a non-sintered area due to emissivity changes between melted and un-melted powder.
   x. Move print head to powder bed 2
   xi. Melt or sinter powder bed 2 per 3D object design per layer with optional addition of alignment marks outside object area.
   xii. Take a picture of 2^{nd} print bed to calculate alignment changes.
   xiii. Repeat until both print beds finish printing.
   For each layer in each powder bed
   xiv. Adjust IR exposure time to keep powder temperature in range
   xv. Adjust object slice file to keep distortion and alignment of printed areas in spec. per camera input.

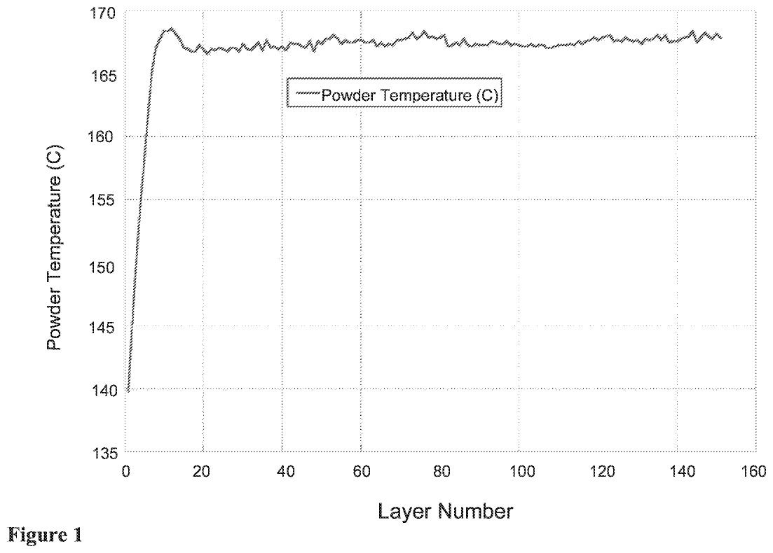

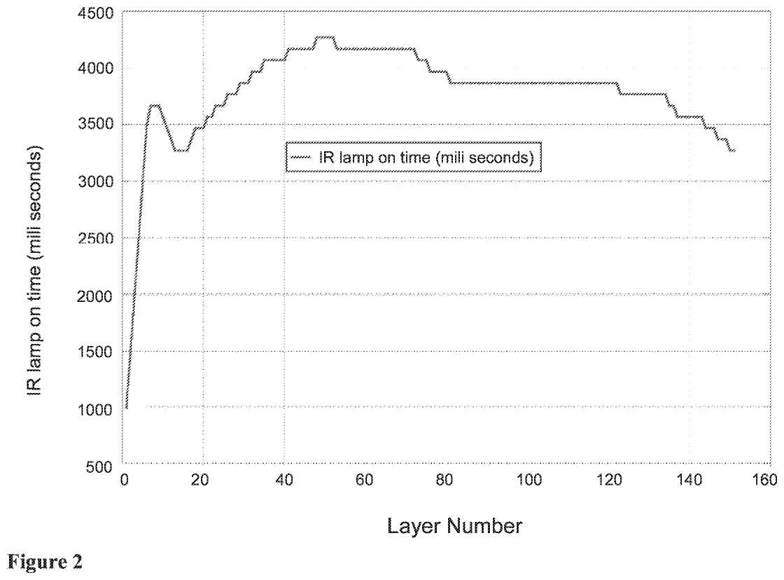

FIG. 1 and FIG. 2 demonstrate the effectiveness of a process of thermal adjustment according to the invention. As depicted in FIG. 1, initial temperature stabilization takes about 15 layers (initial temperature step). Printing starts at layer 20. It is evident that the temperature of the printed layers is maintained at a narrow range of +/−1 degree. In FIG. 2 the presented plot of time required to heat each layer (heating profile) demonstrates that until about the 15th layer, the system is on a learning curve to determine the time required for heating the layer. The IR on time then fluctuates slightly within a range to maintain the required process set point to compensate for temperature changes.

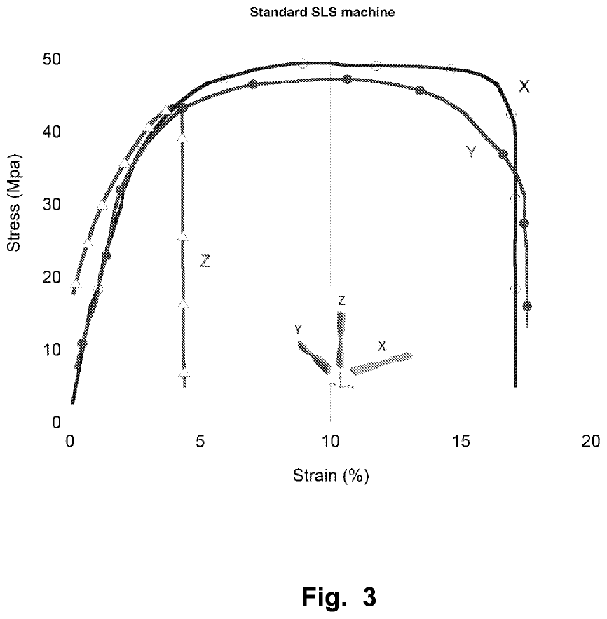

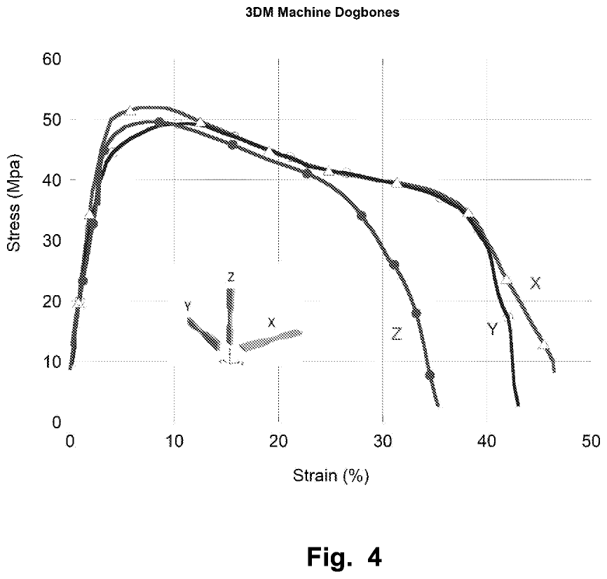

Dog bones were printed using a process of the invention. The dog bones were tested for their mechanical stability and compared to dog bones manufactured on a commercial SLS system. As shown in FIG. 3 and FIG. 4, dog bones formed according to the invention where of higher mechanical stability.

In FIG. 3, mechanical strain of dog bones manufactured on a commercial SLS system is demonstrated. Values x, y and z represent printing orientation in the printer. Samples were tested per ASTM D-638 Type V standard at a speed of 5 mm per min. X direction: Young Modulus 2000 MPa (2%) Stress at max load of 50 N/mm² and elongation fracture point of less than 20%. Y direction: Young Modulus 1900 MPa (2%) Stress at max load of 48 N/mm² and elongation fracture point of less than 20%. Z direction: Young Modulus 2000 MPa (2%) Stress at max load of 43 N/mm² and elongation fracture point of less than 5%.

FIG. 4 presents the results of a mechanical stress test on dog bones manufactured on a system according to the invention, utilizing thermal adjustment protocols recited herein. Values x, y and z represent printing orientation in the printer. Samples were tested per ASTM D-638 Type V standard at a speed of 5 mm per min. X direction: Young Modulus 2200 MPa (2%) Stress at max load of 52 N/mm² and elongation fracture point of 45%. Y direction: Young Modulus 2300 MPa (2%) Stress at max load of 52 N/mm² and elongation fracture point of 42%. Z direction: Young Modulus 2100 MPa (2%) Stress at max load of 50 N/mm² and elongation fracture point of 35%.

Test results for dog bones manufactured according to the invention were better in all orientations x y and z, as compared to those measure for bones manufactured on a commercial SLS system. Most notably the results of fracture point were much better in the scheme X: 45% vs. 18%. Y: 43% vs. 18% and Z: 35% vs. 4%.

These results demonstrate that the mechanical properties of PA12 printed in the protocol described herein were significantly improved compared to state of the art of SLS technology.

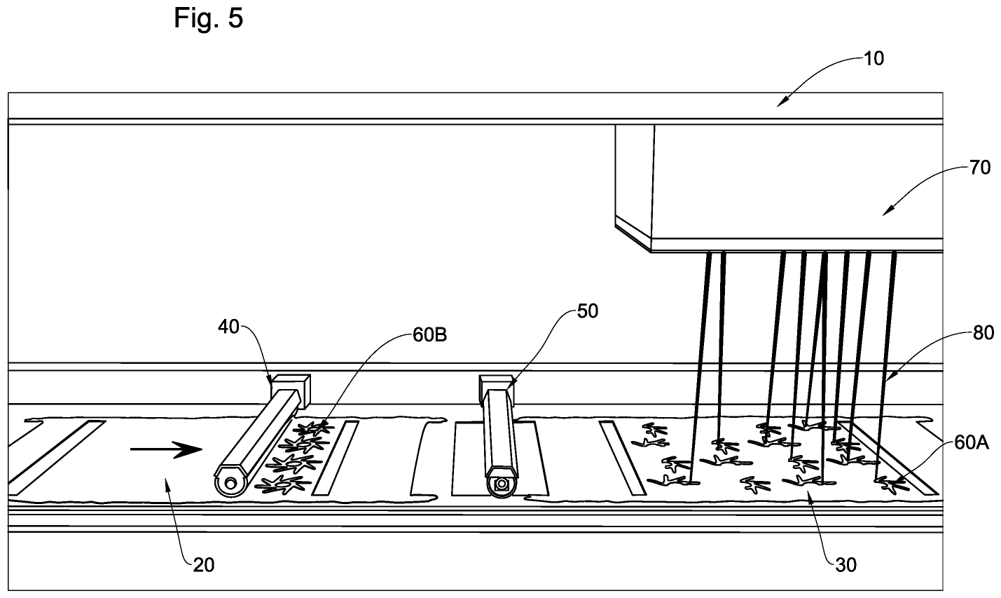

A two-powder bed system 100 is exemplified in FIG. 5. The system 100 comprises two printing areas (20) and (30)—in this specific embodiment being in the form of two spaced apart or separated powder beds; a distinct powder coating assembly comprises of two rollers (40) and (50) for each separate bed; a print head assembly (70) that is positioned in proximity and over the beds; and one or more heating units (not shown in the figure). The print head assembly is movable relative to the beds, or the beds are movable relative to the assembly, or both are movable relative to each other.

In the embodiment depicted in FIG. 5, the two beds are simultaneously operated to produce two or more 3D objects. In the depicted case, each powder bed defines a plurality of printing regions, each permitting construction of a 3D object. A higher number of beds may be used in the same fashion.

As shown in FIG. 5, simultaneously with the recoating of coated and patterned bed (20), comprising a plurality of printing areas (60B), on powder bed (30) a plurality of printing areas (60A) are patterned with laser beams (80) from a print head assembly positioned over the bed (30) by moving the bed or by moving the print head assembly into position over the printing areas, namely in proximity to (or at an effective distance from). Once the thermally treated printing areas (60B) are coated with a further layer, the print head assembly (70) is moved over and into proximity with the recoated printing areas (60B) or bed (20) which are scanned with the laser (80) or any thermal source to affect patterning. At the same time, the coating assembly (50) is moved over the printing areas (60A) or bed (30) to recoat the patterns with a further layer of a powder material. The printing areas or powder beds are re-irradiated and re-coated once and again, in an alternate fashion, by repeating the steps on two or a multiple number of printing areas or powder beds to achieve the simultaneous manufacturing of two or more 3D objects.

1. A powder bed 3D printing system comprising a plurality of printing areas; a powder coating assembly; a print head assembly; and one or more heating units; wherein the plurality of printing areas are in a form of (a) a powder bed having a surface defining at least two printing areas, or (b) two or more powder beds; wherein the system is configured and operable for simultaneous printing of two or more 3D objects.

2. The system according to claim 1, comprising one or more powder beds, at least one of which having a plurality of printing areas.

3. The system according to claim 1, comprising at least two separate powder beds.

4. The system according to claim 1, wherein the powder coating assembly comprises (i) at least one powder coating and/or recoating mechanisms that is optionally heated, each comprising at least one roller or blade, (ii) at least one powder supply unit, optionally one for each of the coating or recoating mechanisms, and optionally (iii) at least one powder overflow cartridge configured for collecting left over powders.

5. The system according to claim 1, wherein the print head assembly is movable over and in proximity of each of the two or more printing areas.

6. The system according to claim 1, wherein the print head assembly comprises a print head in the form of an array of lasers, or laser mirror scanners, or one or more sources of thermal energy.

7. The system according to claim 6, wherein at least one laser in said array of lasers is selected from a quantum cascade laser (QCL), a CO₂ laser, a fiber laser and a diode laser.

8. (canceled)

9. The system according to claim 1, wherein the heating unit comprises at least one infrared emitter, optionally arranged in a form of an array, configured and operable for powder preheating or heating.

10. (canceled)

11. The system according to claim 9, wherein the heating unit further comprises or is associated with one or more temperature sensors configured and operable for measuring a temperature of the powder prior to, during or after powder heating.

12. (canceled)

13. (canceled)

14. (canceled)

15. A process for constructing two or more 3D objects in a simultaneous fashion, said process utilizing a powder bed printing system comprising a printing area in a form of (i) at least two printing areas on a powder bed, or (ii) two or more different powder beds, one or more of the printing areas (i) or (ii) having been previously powder coated and thermally treated, the process comprises:
powder coating one or more printing areas or powder beds and thermally treating said coated printing areas or powder beds; simultaneously therewith treating one or more of the previously powder coated and thermally treated printing areas or powder beds under conditions of selective laser sintering (SLS),
SLS treating the powder coated and thermally treated printing areas or powder beds; and simultaneously therewith coating and thermally treating the SLS treated one or more previously coated and thermally treated printing areas or powder beds, and
repeating the steps to construct the 3D objects.

16. The process according to claim 15, wherein the number of powder beds is between two and ten, one or more of which optionally comprising two or more printing areas.

17. (canceled)

18. (canceled)

19. The process according to claim 15, wherein the SLS comprises use of an array of lasers, or laser mirror scanners, or one or more sources of thermal energy.

20. The process according to claim 19, wherein at least one laser in said array of lasers is selected from a quantum cascade laser (QCL), a CO₂ laser, a fiber laser and a diode laser.

21. The process according to claim 20, wherein the array of lasers is an array of at least two QCL lasers, at least two CO₂ lasers, at least two fiber lasers, at least two diode lasers or a combination of two or more laser types.

22. A process for adjusting temperature of a powder layer comprising at least one powder material in a printing process, the process comprises:
(a) heating with a heating element having a fixed (constant) thermal radiation (amount and spectra) a first powder layer to a temperature T₁, being lower than the sintering temperature of the at least one powder material, over a period t₁;
(b) determining (by direct or indirect temperature measurement) the temperature of the first powder layer;
(c) if the temperature of the first powder layer is lower than T₁ or the sintering temperature, coating a second powder layer on the first powder layer and heating the second powder layer with the heating element for a period t₂ being greater than t₁; and
(d) repeating steps (b) and (c) one or more times until the sintering temperature is achieved.

23. The process according to claim 22, the process comprising:
(a) thermally treating a preformed first powder layer comprising at least one powder material with a heating element having a fixed thermal radiation for a period of time t₁ sufficient to increase the temperature of the first powder layer to a predetermined set-point temperature T₁;
(b) determining the temperature of the thermally treated first powder layer, such that:
(b1) if the temperature determined is T₁, the period of time required to heat the first powder layer is t₁;
(b2) if the temperature determined is lower than T₁, determining a period of time t₂ that is greater than t₁; or
(b3) if the temperature determined is greater than T₁, determining a period of time t₂ that is smaller than t₁;
(c) forming a further powder layer comprising the at least one powder material on said thermally treated first powder layer;
(d) thermally treating said further powder layer with the heating element for a period of time t₂ that is greater than or smaller than t₁;
(e) determining the temperature of the thermally treated further powder layer, such that:
(e1) if the temperature determined is T₁, the period of time required to heat the powder layer is t₂;
(e2) if the temperature determined is lower than T₁, determining a period of time t₃ that is greater than t₂; or
(e3) if the temperature determined is greater than T₁, determining a period of time t₃ that is smaller than t₂;
and repeating steps (c)-(e) one or more times until the period of time required to achieve a temperature T₁, when using the heating element having a fixed (constant) thermal radiation (amount and spectra), is determined.

24. The process according to claim 23, wherein each powder layer is heated once over a period being equal to t₁ or greater than t₁, wherein t₁ is the length of the initial heating session.

25. The process according to claim 23, wherein the preformed first powder layer comprising at least one powder material is a single material layer.

26. (canceled)

27. (canceled)

28. (canceled)

29. (canceled)

30. (canceled)

31. (canceled)

32. (canceled)

33. (canceled)

34. A heating module for use in an additive material manufacturing apparatus/printer, the heating module comprising:
a heating element adjustable to provide heat of a constant energy;
a means for determining temperature of a layered material, at one or more regions thereof;
a control unit adapted to control on/off function of the heating element and optionally further comprising a processor programmed with a set-point temperature that the layered material is to reach.

35. The process according to claim 15, comprising a step of adjusting temperature of the powder coating.

36. The process according to claim 35, wherein the step of adjusting the temperature of the powder coating comprises:
(a) heating with a heating element having a fixed (constant) thermal radiation (amount and spectra) a first powder layer to a temperature T₁, being lower than the sintering temperature of the at least one powder material, over a period t₁;
(b) determining (by direct or indirect temperature measurements) the temperature of the first powder layer;
(c) if the temperature of the first powder layer is lower than the sintering temperature, coating a second powder layer on the first powder layer and heating the second powder layer with the heating element for a period t₂ being greater than t₁; and
(d) repeating steps (b) and (c) one or more times until the sintering temperature is achieved.
